(19) United States
(12) Patent Application Publication
(10) Pub. No.: US 2026/0077701 A1
(43) Pub. Date: Mar. 19, 2026

(54) DETACHABLE MOBILE DWELLING FOR UTILITY TRAILER

(71) Applicant: Howard Russell, Silverton, OR (US)

(72) Inventor: Howard Russell, Silverton, OR (US)

(21) Appl. No.: 19/330,825

(22) Filed: Sep. 17, 2025

Related U.S. Application Data
(60) Provisional application No. 63/696,386, filed on Sep. 19, 2024.

(51) Int. Cl. B60P 3/34; B60S 9/04; B62D 63/08

(52) U.S. Cl. CPC B60P 3/34; B60S 9/04; B62D 63/08

(57) ABSTRACT

Detachable mobile dwelling adapted for use with a household garden utility trailer, comprising a frame comprising a plurality of interconnected structural floor members forming a floor frame portion, a plurality of interconnected structural side wall members forming at least one side frame portion interconnected with the floor frame portion; and a plurality of upper structural members, forming front, top, and rear frame members forming an upper frame portion, each of the front, top, and rear frame members interconnecting with at least one of the floor frame portion and the at least one side frame portion, an entry and exit access portal, and at least one releasable attachment and centering device for securing and centering the mobile dwelling on the utility trailer.

### CONTINUITY AND CLAIM OF PRIORITY

This US non-provisional patent application claims the benefit and priority of U.S. provisional patent application Ser. No. 63/696,386, filed Sep. 19, 2024.

### FIELD

The disclosure relates to detachable mobile dwellings, such as may be used for camping generally, such as for example an over-the-cab camper detachable from a pickup-type wheel base, and more particularly to a detachable mobile dwelling structure and related attachment device adapted for repeated selective attachment of the mobile dwelling structure to a wheeled support base—when the mobile dwelling is desired for transport, camping, work, or other dwelling use—and detachment from the wheeled support base-when the wheeled support base is desired for other hauling-type use.

### BACKGROUND

Many persons do not have adequate space in front of their homes or in their garage, or cannot otherwise afford to store in a commercial facility, a camper or a travel trailer. This greatly limits the number of persons with owned or rented homes, for example in the US, that are able to feasibly own a traditional travel trailer or camper.

Detachable mobile camping dwellings are commonplace in the prior art in the form of over-the-cab campers able to be attached, detached, and reattached, to a pickup truck-type bed and wheelbase. Such campers are able to be optionally detached from the pickup truck, or flatbed pickup truck, to allow use of the truck bed/flatbed for other hauling use, however precisely located is needed, as serving to locate them in the bed of a pickup without sophisticated electronic video sighting and/or guidance systems is not known.

Furthermore, of course, travel trailers are well-known, wherein the mobile dwelling (camper) portion is securely, non-detachably, attached to a separate, otherwise non-motorized, wheeled support base. Such trailers are adapted to be removably attached to a hitch of a motorized vehicle for transport, and are likewise adapted for later re-attachable detachment from the hitch when the motorized vehicle is desired for other uses such as passenger transport or hauling of other types of trailers.

Nevertheless, there remains a need for a detachable structure adapted for repeated selective attachment to a common garden utility trailer-such as a smaller 4×6 foot, 5×8 foot, 6×8 foot, 8×10 foot, or other commonly-sized garden utility trailer, when the mobile dwelling is desired for transport, dwelling, and camping use with the utility trailer, and detachment from the trailer when the trailer is desired for other hauling use, such as for example removal of yard debris or delivery of yard-related, or other, materials to, or form, one's house. Such common garden utility trailer often have detachable box-like, or rectangular-like, sides. And further, there is needed a way to securely, though releasably, attach a detachable mobile dwelling to a trailer bed while at the same time precisely centering the mobile dwelling relative to the extents of the bed.

The term monolithic is defined in the dictionary as, formed of a single large stone, and as applied to a building, being very large and characterless, and in particular, faceless (in the sense of being uniform). However, the term “as if monolithic” is used herein to describe a structure with separate parts but which are combined and fastened together so as to be capable of functioning as an integral and larger building whole, and to be capable, for example, of being moved as a whole (as a unitary piece of stone), as for example would be the case being lifted with a winch cable dangling from a garage support and attached at a single point, or multiple points, near the top of the monolithic mobile dwelling unit, and also so that the monolithic mobile dwelling unit can stand on its own, support weight on top of it, and successfully resist substantial shifting forces, lateral forces, and shear forces, all without damage to, destruction of, or disassembly of, the structure.

There is also needed a detachable dwelling unit structure which is as if monolithic in the sense that it may be readily safely lifted from a central reinforced upper location, or locations; safely side-jacked into for positioning being lowered on a utility trailer bed either with the trailer's sides removed or not; or readily safely rolled into position up a ramp onto such a standard garden utility trailer bed.

### SUMMARY

The present disclosure addresses various problems and needs associated with commonly-available detachable mobile camping dwellings and travel trailers-such as the cost of storage for a larger camper or trailer in a dedicated commercial facility apart from one's own home garage, or the need for having two vehicles such as a travel trailer and a utility trailer, each with their attendant storage requirements and costs. Thus, the present invention presents a novel way of implementing a detachable mobile dwelling with a commonly-available, likely smaller, on the order of 4×8 foot, 5×8 foot, 6×8 foot, or 8×10 foot utility trailer, one like a common household might already have sitting on their property (as in a conventional residential neighborhood), and which if such a mobile dwelling were detached it could readily be stored in the user's garage.

An embodiment of the present disclosure comprises a detachable mobile dwelling adapted for selective attachment and detachment from a utility trailer having picket stake pockets otherwise for retaining a typically rectangular wall-like structure (e.g., having front, sides, and rear, walls detachable from the bed, or base, of the trailer), the utility trailer being adapted to being towed behind a motor vehicle. Preferably, the dwelling body comprises structural floor, wall, and upper, or ceiling, portions, and an entry and exit access portal in at least one of the plurality of side wall member portions and the plurality of upper structural member portions.

Further, the detachable mobile dwelling comprises at least one of a plurality of types of securement devices, such as at least one releasable attachment and centering device combination, comprising a stud portion non-releasably attached to the floor portion for engaging with one of the picket stake pockets, and further comprising an integrator comprising one of a threaded bolt member, a non-threaded pin member, and a combination threaded bolt member and non-threaded pin member, for fixing the stud portion relative to the picket stake pocket for securely releasably interconnecting the detachable dwelling and the utility trailer while also aiding in centering, and/or locating, the floor frame portion on the utility trailer.

In accordance with a preferred embodiment of the disclosure, the at least one attachment and centering device combination further comprises an adapter portion adapted for engaging with the picket stake pocket, and wherein the integrator is adapted for fixing the stud portion and the adapter portion relative to the picket stake pocket for releasably interconnecting the detachable dwelling and the utility trailer while aiding in centering, and/or locating, the floor frame portion on the utility trailer. The at least one attachment and centering device combination may be comprised of one of nesting conical, pyramidal, or rectangular, members comprising a seat and seated portion for aligning communicating receptacles for a threaded receptacle and bolt combination, wherein the bolt portion comprises a threaded bolt, such as a threaded lag bolt, and may comprise a reduced squared, hexed, pointed, or other type of faceted end (such as an angled tip as shown in FIG. 7) that can pass freely through a non-threaded receptacle portion, up into a threaded receptacle portion, and adapted for optional enhanced securement with a box-head washer. Alternatively, an automated electro-mechanical clamp to prevent loosening of the lag bolts may be used during or after transport.

Preferably, in accordance with an aspect and embodiment of the disclosure, the detachable mobile dwelling further comprises one of electrical, water, and propane fittings/connections which are standard with more traditional campers and trailers.

In accordance with an aspect and embodiment of the disclosure, the detachable mobile dwelling body is provided structurally to be as if monolithic with one of an upper central hook, or pick point, or a plurality of balanced lifting hooks, adapted so that the mobile dwelling may be readily safely lifted from a central reinforced upper location, or locations and lowered into position onto a utility trailer bed. This is accomplished wherein the floor, side, and upper portions are suitably bonded or attached to form a structural frame. Such may be fixed/attached as with wood fixed by screws, nails, glue, other adhesives, and the like, or as welded in a metal (such as preferably mostly aluminum for its lightweight and strength properties), or even steel-framed if a larger vehicle is available to pull the trailer and detachable mobile dwelling.

In accordance with another aspect and embodiment of the invention, the side portion may comprise a plurality of side portions, and there is provided a jack system, such as may comprise side jacks attached adjacent, or attached to, front and rear portions of sides of the detachable mobile dwelling, such as may be employed to lift the mobile dwelling to allow location of a utility trailer, such as a common garden utility trailer, under the mobile dwelling to allow it to be lowered into place and releasably attached onto the utility trailer with one or more attachment means. The jacks may be wheeled. And the jacks may be detachable with a horizontal member able to be slid into a sleeve mounted to, or under, the mobile dwelling, such as with a steel sleeve welded to a steel plate adapted for carrying the non-releasable portion of the releasable attachment and centering device combination. Thus, in accordance with an aspect of the disclosure, the detachable mobile dwelling may further comprise a jack system, such as a side jack system, wherein the detachable mobile dwelling is able to jacked up for installation and removal of the mobile dwelling from the utility trailer using the jack system, wherein the at least one releasable attachment and centering device combination further comprises an attached (as by welding steel to steel) jack sleeve, such as a side jack sleeve, adapted for releasably receiving a horizontal member of the jack system.

In accordance with another aspect and embodiment of the invention, there are provided wheels, such as optionally even omni-directional wheels, mounted on an underside of the mobile dwelling, which together with one or more ramps leading to the bed of the utility trailer, and adapted for allowing pulling backward, or forward—as with a winch—the detachable mobile dwelling up into place on the bed of the common garden utility trailer for tying down. Alternatively, wheels may be beneficially adapted for installation at floor engaging portions of each side jack.

In accordance with an aspect of the disclosure, the at least one releasable attachment and centering device combination comprises an adapter for interfacing with the portion of the releasable attachment and centering device combination that is non-releasably attached to the floor frame portion of the mobile dwelling for positionally fixing a threaded lag screw adapted for location in one of the picket fence receptacles of the utility trailer.

In accordance with an aspect of the disclosure, the releasable attachment and centering device combination further comprises a threaded bolt adapted for screwing into, or otherwise passing through a hole in, the adapter and having a faceted leading portion, such as an angled tip leading portion, adapted for facilitating securement of the threaded bolt within the portion of the releasable attachment and centering device combination that is non-releasably attached to the floor frame portion of the mobile dwelling for fixing the non-releasably attached portion of the releasable attachment and centering device combination relative to the corresponding stake pocket and aiding in centering the floor frame portion on the utility trailer.

In an embodiment, the releasable attachment and centering device combination further comprises a positioning member comprising one of mating cones and mating pyramid-shaped faces adapted for centrally aligning communicating of receptacles for the lag screw and aiding in securing positioning of the mobile dwelling relative to the utility trailer.

In accordance with an aspect and embodiment of the disclosure, the detachable mobile dwelling further comprises a side jack system, wherein the mobile dwelling is able to be jacked up for installation and removal of the mobile dwelling from the utility trailer using the side jack system, the at least one releasable attachment and centering device combination further comprising an attached side jack sleeve adapted for releasably receiving a horizontal member of the side jack system. Preferably, the side jack system comprises a plurality of side jack members, wherein each side jack member comprises a wheeled attachment for enabling wheeling the mobile dwelling on a surface when it is not installed on the utility trailer.

In accordance with an aspect and embodiment of the disclosure, there is provided a detachable mobile dwelling adapted for use with a utility trailer, such as a common garden utility trailer, comprising: a structural frame, preferably comprised of welded aluminum, comprising: a plurality of interconnected structural floor members forming a floor frame portion; a plurality of interconnected structural side wall members forming at least one side frame portion interconnected with said floor frame portion; and a plurality of upper structural members, forming front, top, and rear frame members each interconnecting with at least one of said floor frame portion and said at least one side frame portion. The detachable mobile dwelling comprises an entry and exit access portal in at least one of the plurality of side wall members and the plurality of upper structural members.

The detachable mobile dwelling of this aspect and embodiment further comprises a plurality of releasable attachment and centering device combinations, each such combination comprising a stud portion, a corresponding adapter portion, and a corresponding integrator portion, the stud portion being adapted for engaging and interconnecting with the floor portion, the adapter portion being adapted for engaging with a corresponding one of the plurality of picket stake pockets of the utility trailer, and the integrator portion comprising on of a threaded bolt member, a pin member, and a combination threaded bolt member and pin member, the integrator portion being adapted for interconnecting the adapter portion and the stud portion for aiding in centering and fixing the mobile dwelling body relative to the corresponding stake pocket to aid in releasably interconnecting and centering the floor frame portion on the utility trailer via its stake pockets

The detachable mobile dwelling may further comprise a jack system, such as a side jack system, wherein each of the plurality of releasable attachment and centering device combinations may further comprise an attached jack sleeve, such as a side jack sleeve, for example attached to the sides, or a floor portion, of the trailer, as for example being welded to “sled” plates attached, as with bolts to the underside of a structural floor frame portion of the mobile dwelling, adapted for releasably receiving a horizontal member of the side jack system to enable the mobile dwelling to be lifted to thereby enable deposit of the mobile dwelling on, and for removal of the mobile dwelling from, the utility trailer.

In accordance with an embodiment, there is provided a detachable mobile dwelling further comprising wheel members, such as for example omni-directional wheels, mounted to each at least one releasable attachment and centering device combination portion which is non-releasably attached to the floor frame, wherein the frame portions are welded to enable the detached detachable mobile dwelling to be rolled on a flat surface, such as a garage floor, or to be rolled up ramps to enable deposit on, and removal from, the utility trailer.

The detachable mobile dwelling may beneficially, for structural reasons, further comprise laminated aluminum and plastic floor and siding members attached to the frame portions.

In accordance with an aspect and embodiment of the disclosure, thus, there is provided a detachable mobile dwelling combined with a utility trailer having had its rectangular-like sides otherwise used for utility trailer purposes removed and the detachable mobile dwelling releasably attached and properly positioned and centered on the utility trailer bed. This is accomplished since non-releasable portions of the releasable attachment and centering device combination(s) are preferably adapted for seating in, and thus centering, corresponding stake pockets typically around the periphery of the utility trailer bed.

In accordance with an aspect and embodiment of the disclosure, there is provided a detachable mobile dwelling adapted for use with a common household garden utility trailer, comprising: an aluminum welded frame comprising: a plurality of interconnected structural floor members forming a floor frame portion; a plurality of interconnected structural side wall members forming at least one side frame portion interconnected with said floor frame portion; and a plurality of upper structural members, forming front, top, and rear frame members each interconnecting with at least one of said floor frame portion and said at least one side frame portion.

The detachable mobile dwelling in accordance with this aspect of the disclosure comprises an entry and exit access portal in at least one of the plurality of side wall members and the plurality of upper structural members and a ventilation portal in the upper frame portion.

The detachable mobile dwelling in accordance with this aspect of the disclosure comprises a plurality of releasable attachment and centering device combinations, a portion of each of which is non-releasably attached to the floor frame portion, a portion of each of which is adapted for engaging with a corresponding picket stake pocket of the utility trailer for aiding in centering the portion of said at least one releasable attachment and centering device that is non-releasably attached to the floor frame portion within each of corresponding ones of a plurality of picket stake pockets of the utility trailer, and comprising a threaded bolt member for fixing each non-releasably attached portion of each releasable attachment and centering device combination relative to its corresponding stake pocket, to aid in releasably interconnecting the floor frame portion, and hence the detachable mobile dwelling itself, to the utility trailer and for aiding in centering the mobile dwelling on the utility trailer relative to the utility trailer picket stake pockets. The detachable dwelling may be further comprised of laminated aluminum and plastic floor and siding members attached to the frame portions.

Like another embodiment, the detachable mobile dwelling of this embodiment may comprise frame portions suitably welded, and wherein at least one pick point is secured to the upper frame portion of the dwelling to allow the dwelling to be structurally adapted to be lifted from of a central line, such as for example a winch line, from above via the at least one pick point.

Still further, like another embodiment, the detachable mobile dwelling of this aspect and embodiment may further comprise a side jack system, wherein the frame portions are welded to enable the mobile dwelling to be jacked from the side jack system, wherein each of the plurality of releasable attachment and centering device combinations further comprises an attached side jack sleeve adapted for releasably receiving a horizontal member of the side jack system to enable the mobile dwelling to be lifted from the sides to thereby enable deposit on, and for removal from, the utility trailer.

In such case, the detachable mobile dwelling side jack system preferably comprises a plurality of side jack members, wherein each side jack member may further comprise a wheeled attachment for enabling wheeling the mobile dwelling on a surface when it is not installed on the utility trailer, but jacked up using the side jack system. And of course, it will be appreciated that the side jack system may be attached in any of a number of different ways and locations, whether at corners of the mobile dwelling, at front and rear corners, or along side thereof, without departing from the disclosure as set forth in claims of varying breadth appended hereto.

There is further provided any of the aforementioned detachable mobile dwellings combined with a utility trailer, whether having had its box-like, or rectangular-like, sides removed or not, and with the detachable mobile dwelling releasably attached to the utility trailer.

In accordance with an aspect and embodiment of the disclosure, there is provided a releasable attachment and device system adapted for use in detachably attaching a mobile dwelling comprising a mobile dwelling body having a floor portion to a utility trailer having a plurality of picket stake pockets around a periphery of a bed of the utility trailer, comprising: a stud portion, a corresponding adapter portion; and a corresponding integrator portion, wherein the integrator portion comprises one of a threaded bolt member, a pin member, and a combination threaded bolt member and pin member. The integrator of this embodiment, together with the stud portion and the adapter portion, are adapted for fixing and centering the floor portion of the mobile dwelling to the bed of the utility trailer via a plurality of the plurality of picket stake pockets.

In an embodiment of the releasable attachment and centering combination of the disclosure, the stud portion further comprises a plate adapted to be non-releasably attached to the floor portion, and the stud portion is also adapted for engaging with one of the plurality of picket stake pockets. In this embodiment, the adapter portion is comprised of one of a flanged seat for interfacing with said stud portion and a flanged cap, the adapter portion being adapted for engaging the one of the plurality of picket stake pockets. Further, in this embodiment, the integrator comprises a partially-threaded bolt member, the integrator being adapted for fixing the stud portion and the adapter portion to each other and relative to the picket stake pocket to be adapted for releasably interconnecting the detachable dwelling and the utility trailer while also being adapted for aiding in centering the floor frame portion on the utility trailer. As used in this application, the term “centering” means to appropriately locate the floor portion, and hence the detachable mobile dwelling unit itself, forward and aft, as well as side-to-side, on the trailer bed, and this helps in securing adequate towability of the trailer and mobile dwelling unit combination.

In accordance with an aspect and embodiment of the disclosure, the releasable attachment and centering device may further comprise an attached jack sleeve adapted for releasably receiving a horizontal member of a jack system, such as a side jack system, and adapted to enable the mobile dwelling to be lifted to enable depositing the mobile dwelling on, and for removal of the mobile dwelling from, the utility trailer.

The aforementioned aspects and embodiments of the disclosure address the need for securely and precisely locating and centering a detachable mobile dwelling relative to a trailer bed.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings.

### BRIEF DESCRIPTIONS OF DRAWINGS

FIG. 1 shows a side view of a partially-skinned mobile dwelling and frame in accordance with an aspect and embodiment of the disclosure shown being lifted with a winch line from a standard utility trailer.

FIGS. 2A-C show various views of a preferred alignment and securement system for use with secure attachment/detachment of the mobile dwelling of the disclosure to picket stake receptacles for a standard utility trailer, there being shown detailed views of sectioned securement receptacles and box-head washers adapted for securement in floor frame members, and showing securement and positioning adapters, lag bolts and mating positioning members for positioning and releasably securing the mobile dwelling to the common, otherwise picket side-walled, utility trailer.

FIG. 3 shows a front view of an at least partially-skinned mobile dwelling and frame in accordance with an aspect and embodiment of the disclosure shown with side-jacks thereon adapted for lifting and depositing the same onto the bed of a standard utility trailer.

FIG. 4 shows a rear view of an at least partially-skinned mobile dwelling and frame in accordance with an aspect and embodiment of the disclosure shown with an optional rear hatch portion as is typical with tear-drop-type trailers.

FIG. 5A shows a side view of an alternative embodiment of a mobile dwelling in accordance with an aspect and embodiment of the disclosure shown with a wheeled system adapted for use with a ramp and alternative positioning and securing system to load and secure the dwelling onto the utility trailer, either by pushing the same or using a winch to load and unload the same, it being appreciated that such may be implemented with either a trailer having it's box-like, or rectangular-like, sides removed, and it further being appreciated that such mobile dwelling may be narrower to fit between the wheels of the trailer.

FIG. 5B shows a front cross section view of an exemplary alternative wheel, positioning, and securing, system adapted for use with a ramp to load and secure an alternative wheeled mobile dwelling on a utility trailer.

FIG. 5C shows a side cross section view of the exemplary alternative wheel positioning, securing, system adapted for use with a ramp to load and secure the alternative wheeled mobile dwelling on a utility trailer.

FIG. 6 shows a pair of walled rails, or ramps, for facilitating loading of an alternative wheeled dwelling onto a utility trailer.

FIG. 7 shows a partial section view of an alternative embodiment of a positioning and securing system for use with secure attachment of the mobile dwelling of the disclosure to picket stake receptacles for a standard utility trailer.

FIG. 8 shows an embodiment of a pair of preferably steel front sled plates, each adapted for installation on a front corner portion of a floor frame portion of a mobile dwelling, each sled plate comprising a stud portion, a side-jack receptacle portion, and a steel plate portion with holes for attaching the steel plate portion with screws to an aluminum frame portion of the floor portion.

FIG. 9 shows another pair of preferably steel rear sled plates, each adapted for installation on a rear corner portion of the floor frame portion of the mobile dwelling, each sled plate comprising a stud portion, a side jack receptacle portion, and a steel plate portion with holes for allowing attaching the steel sled plate portion with screws to the aluminum frame portion of the floor portion.

FIG. 10 shows a pair of alternative embodiment preferably steel front/rear sled plates (two such plates are shown of four total), each adapted for installation on a front/rear portion of a corner portion of a floor frame portion of a mobile dwelling, each sled plate comprising a stud portion and a plate portion with holes therein for attaching the plate portion with screws to an aluminum frame portion of the floor portion.

FIGS. 11A and B show bottom perspective views of two different steel sled plates, one with a jack sleeve and one without the jack sleeve, and mounted to the floor frame of a detachable mobile dwelling in accordance with an embodiment of the disclosure.

### DETAILED DESCRIPTION

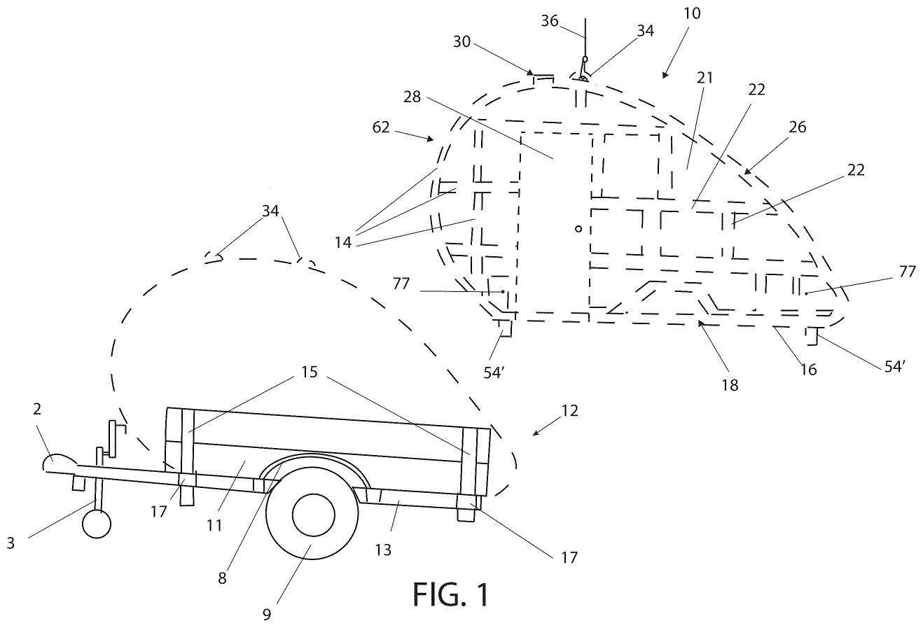

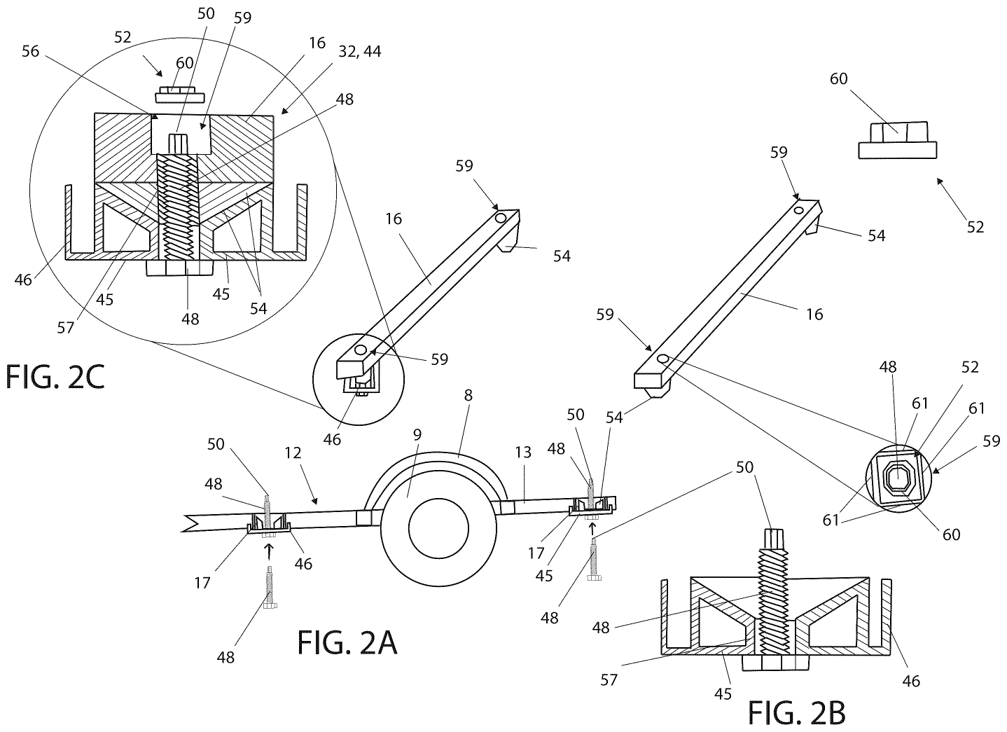

Referring to FIGS. 1 and 2A-2C, there is provided a detachable mobile dwelling 10 adapted for use with a household garden utility trailer 12 having a central wheel 9, and preferably having removable sides 11 staked to the trailer frame and floor 13, wherein the sides 11 have pickets 15 retained in fixed receptacles 17 preferably on the sides and/or front and rear of the trailer. The trailer preferably has a hitch 2 and a wheeled jack 3. The mobile dwelling comprises a frame 14, comprising: a plurality of interconnected structural floor members 16 forming a floor frame portion 18, a plurality of interconnected structural side wall members 20 forming at least one side frame portion 22 (but preferably two side frame portions 22), each side frame portion being interconnected with the floor frame portion, and a plurality of upper structural members 24, forming front, top, and rear frame members forming an upper frame portion 26, each of the front, top, and rear frame members interconnecting with at least one of the floor frame portion 18 and the at least one side frame portion 22. The upper frame 26 may be teardrop, square teardrop, rectangular, or other common frame shape without departing from the broader inventive aspects. The frame portions of the trailer may be constructed of wood, steel alloy, or plastic, but preferably are constructed of welded aluminum so as to be both lightweight and as if monolithic as defined herein.

The mobile dwelling 10 further preferably comprises an entry and exit access portal, such as a door, 28 in one of the members, and a vent 30 in the upper frame portion 26. The mobile dwelling 10 also further comprises at least one releasable attachment system 32, 44 (see e.g., FIG. 2C) for securing the mobile dwelling 10 to the utility trailer 12.

Preferably, the detachable mobile dwelling frame portions 18, 22, 26 are suitably bonded, attached (as with glue and/or threaded screws), or preferably welded, and in an embodiment there is provided at least one pick point 34 secured to the upper frame portion 26 of the dwelling 10 to allow the dwelling to be structurally adapted to be lifted from of a central winch line 36 from above via the at least one pick point.

While a single pick point 34 may be preferred, which may be electronically positionable in an embodiment to account for variable weight and loading conditions, a plurality of pick points (preferably three or four pick points) may also be used for stability regardless of variable loading.

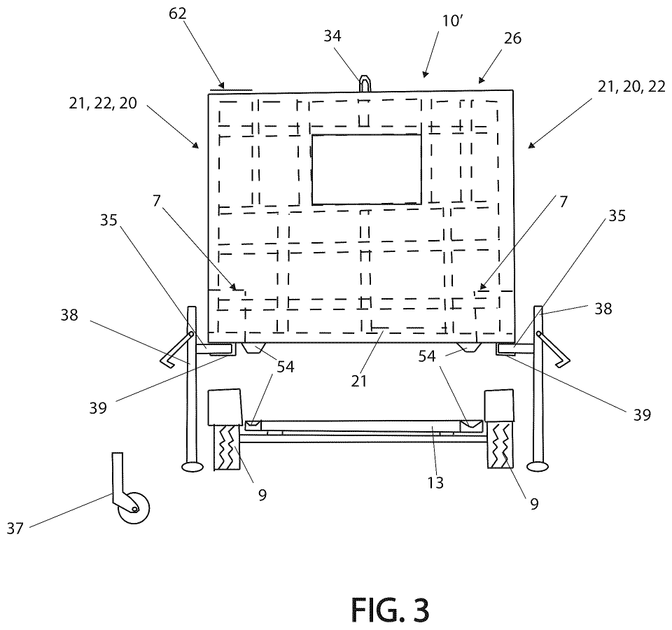

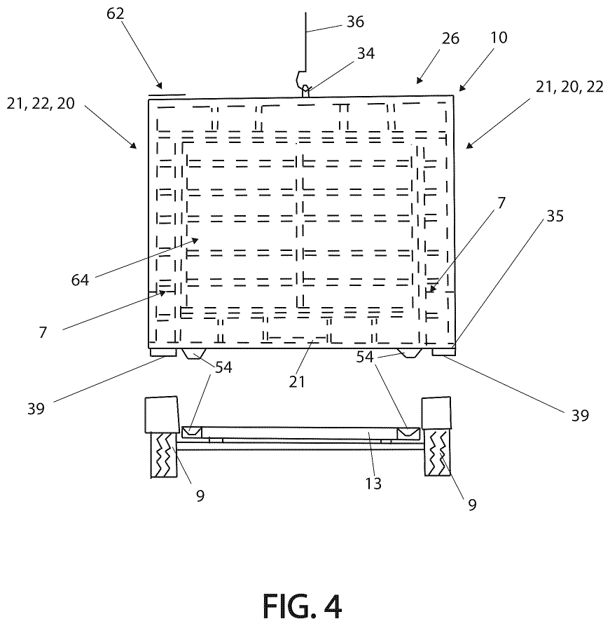

In another embodiment shown in FIG. 3, the detachable mobile dwelling 10′ is provided shown in a rear view thereof wherein the frame portions 18, 22, 26 are suitably bonded, attached, or welded, to enable the mobile dwelling to be jacked from side jacks 38 adapted to be lifted from the sides 20, 22 to thereby enable deposit on, and removal from, the utility trailer 12. The jacks may be wheeled as indicated at 37, for example by having a foot pad of each jack be interchangeable with a castor-wheeled adapter that is attachable, as for example with a pin (such as a D-ring or flanged pin) and seat combination. And the jacks may be detachable with a horizontal support member 35 able to be slid into a sleeve 39 welded to a plate (each sleeve being discussed hereafter). Of course, though there are shown 2 jacks 38 in FIG. 3, it will be appreciated that preferably there would be four such jacks, two for the front corners, or portions, of the dwelling and two for the rear corners, or portions, of the dwelling. The mobile dwelling 10′ (as with mobile dwelling 10 of FIG. 4) may optionally be further comprised of laminated floor and siding members 21 attached, as by glue or screws, to the floor, side, and/or upper frame portions. For a curved upper surface, as in the case of a tear-drop dwelling design, the curved upper surface may be comprised of a flexible sealed PVC, sheet aluminum, or laminated wood covering 62 attached to corresponding frame members as with glue and or screws as is known in the art. Further, as shown in FIG. 3, it will be appreciated that the sides of the dwelling 10′ would need to be adapted with a cut-out as shown with dashed line 7 of some kind to allow the dwelling to sit on the bed 13 of the utility trailer, while at the same time clearing the fenders and wheels 9 of the trailer.

Referring more specifically to FIGS. 2A-C, the at least one releasable attachment device 32, 44 of the mobile dwelling 10, 10′ and comprising an adapter 45 with flanges 46 for positionally fixing a threaded steel alloy lag screw 48 adapted for location in a picket fence receptacle 17, preferably comprised of a steel alloy, of the utility trailer 12.

The system 32, 44 may further comprise a positioning member comprising one of mating cones 54, mating pyramid-shaped faces 54, or a rectangular stud 54, adapted for centrally aligning communicating of receptacles 56 (whether fully-threaded or partially-threaded) for the lag screw 48 and aiding in securing positioning of the mobile dwelling 10, 10′ relative to the utility trailer 12. The upper positioning device 54 (mating cone, pyramid, or rectangular stud 54), extends attached permanently from a frame member 16 of the floor frame portion 18 of the dwelling 10. When sitting on the floor, or on a cart in the garage, the dwelling 10 may sit atop these positioning devices 54. The communicating lag bolt receptacles 56 may be comprised of steel alloy insets 57 into the adapters 46 and positioning devices 54, which may be made of aluminum, steel alloy, or cast metal. Because these positioning devices 54 may be used to support the weight of the dwelling 10, steel alloy may be the best choice for their construction.

There are preferably provided a plurality of systems 32. 44, at least one for each corner of the dwelling 10, 10′ adapted for positioning and securing releasable attachment to each of at least four rectangular structural picket stake receptacles otherwise for holding in place useful side walls (for containing debris and other materials during hauling use) of the utility trailer 12.

Preferably, the lag screw 48 adapted for screwing into, or otherwise passing through, the adapter 46 comprises a faceted leading portion 50 adapted for securement from above within the floor frame portion 16 with a corresponding box-head square washer 52 to prevent loosening of the lag screw, wherein the outer extents of the square washer are square so as to lie within walled portions 61 within a receptacle 59 of an upper portion of the system 44. Integral with the box-head square washer 52 is an inner box-head socket 60 (whether 6-sided, 8-sided, or more to facilitate easy matching) that is adapted to rest on and engage with the facets of the faceted leading portion 50 of the lag screw 48, to prevent the lag screw from loosening as long as the washer sits on the faceted leading portion 50 of the lag screw 48. Each system 44, and the adapter 46 thereof, are designed to be inserted, from the bottom, into the picket receptacles 17 of the trailer, further adapted for receiving the lag screw from below interconnecting the adapter 46 and at least partially-threaded receptacles 57 in the conical, or pyramidal, positioning devices 54. In this way the mating conical, or pyramidal, positioning devices 54 help align the threaded receptacles for easy installation of the lag screws 48. Easy installation of the lag screws 48 is further facilitated in that only one of the portions 54, 46 of the system need be threaded to make it easier to insert the lag screws 48. A utility door 77 may be provided to allow easy access to the receptacles 56 suitable for inserting the boxhead socket 60 and square head washer 52 combination to lock the lag bolt 48 in place.

Optionally, there may be provided an automated, or semi-automated, electromechanical means for securing the faceted portion 50 of the lag screw 48 as the mobile dwelling 10, 10′ is installed and secured on the trailer 12.

Referring also to FIG. 4 (a rear view of an alternative dwelling and trailer), the mobile dwelling 10 (as with mobile dwelling 10′) may optionally be further comprised of laminated floor and siding members 21 attached, as by glue or screws, to the floor, side, and/or upper frame portions. For a curved upper surface, as in the case of a tear-drop dwelling design, the curved upper surface may be comprised of a flexible sealed PVC, sheet aluminum, or laminated wood covering 62 attached to corresponding frame members as with glue and or screws as is known in the art. Further, the dwelling 10, 10′, and its frame member portions 18, 22, 26, in accordance with an aspect and embodiment, may be provided with an optional rear hatch portion 64 as is typical with tear-drop-type trailers generally. Further, as shown in FIG. 4, it will be appreciated that the sides of the dwelling 10 would need to be adapted with a cut-out as shown with dashed line 7 of some kind to allow the dwelling to sit on the bed 13 of the utility trailer, while at the same time clearing the fenders and wheels 9 of the trailer.

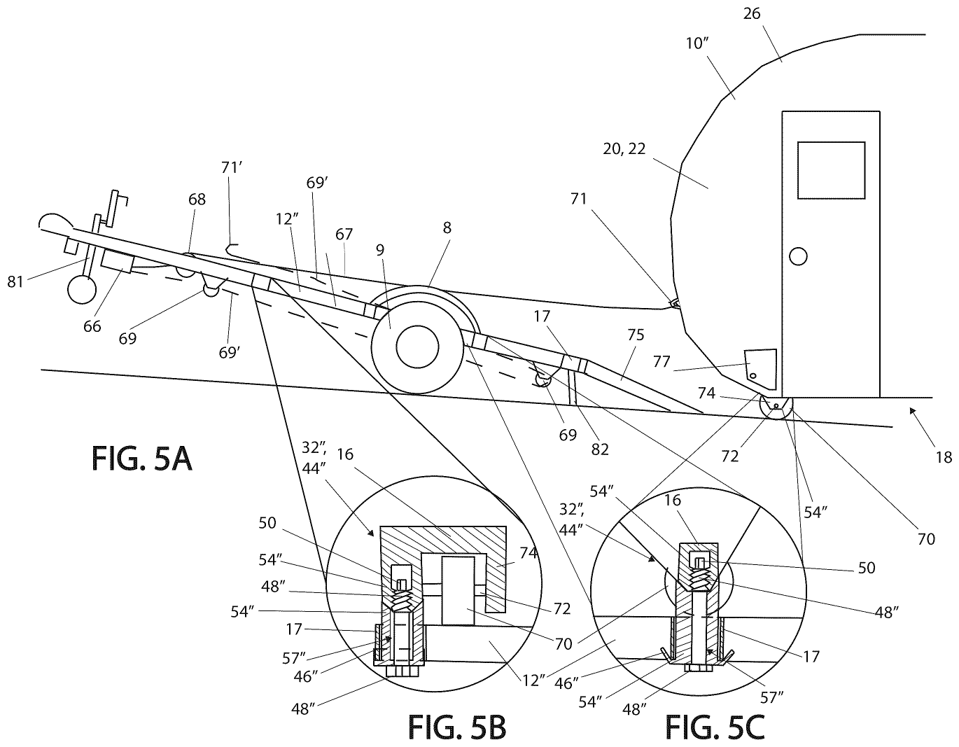

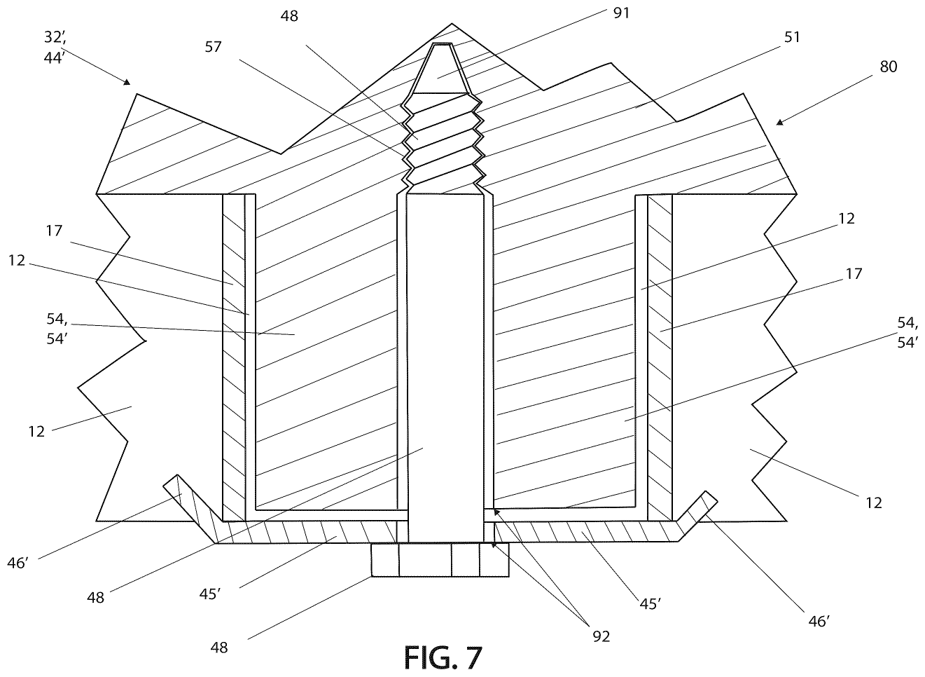

Referring to FIGS. 5A-C, there is provided an alternative mobile dwelling 10″ wherein wheel members 70 (preferably omnidirectional wheel members) are mounted on the underside of the floor frame portion 18 and further comprise an at least one releasable attachment device 32″ of the mobile dwelling 10″, which similarly to previously-described embodiments, preferably comprises a system 44″ further comprising an alternative (longer vertical shaft) adapter 46″ for positionally fixing a threaded steel alloy lag screw 48″ adapted for location in a picket fence receptacle 17, preferably comprised of a steel alloy, of the utility trailer 12″. The adapter 46″ may be a single member as shown in FIGS. 5B and C, or a dual member as shown at 45′ and 54′ in FIG. 7.

The system 32″, 44″ further comprises a positioning member comprising one of mating cones 54″ and mating pyramid-shaped faces 54″ adapted for centrally aligning communicating of receptacles 56″ (whether fully-threaded or partially-threaded) for the lag screw 48″ and aiding in securing positioning of the mobile dwelling 10″ relative to the utility trailer 12″. Similar to a previously-described embodiment, the communicating lag bolt receptacles 56″ may be comprised of steel alloy insets 57″ into the adapters 46 and positioning devices 54″, which may be made of aluminum, steel, or cast metal.

There are preferably provided a plurality of systems 44″, at least one for each corner of the dwelling 10″ adapted for positioning and securing releasable attachment to each of at least four rectangular structural picket stake receptacles 17 otherwise for holding in place useful side walls (for containing debris and other materials during hauling use) of the utility trailer 12″.

Preferably, the lag screw 48″ adapted for screwing into, or otherwise passing through, the adapter 46″ comprises a faceted leading portion 50 adapted for securement from above within the floor frame portion 16 with a corresponding box-head square washer 52 (similar to that shown in FIGS. 2B and C) to prevent loosening of the lag screw, wherein the outer extents of the square washer are square so as to lie within walled portions 61 within a receptacle 59 of an upper portion of the system 44″. Integral with the box-head square washer 52 is an inner box-head socket 60 (whether 6-sided, 8-sided, or more to facilitate easy matching) that is adapted to rest on and engage with the facets of the faceted leading portion 50 of the lag screw 48, to prevent the lag screw from loosening as long as the washer sits on the faceted leading portion 50 of the lag screw 48, 48″. Each system 32″, 44″, and the adapter 54″ thereof, are designed to be inserted, from the bottom, into the picket receptacles 17 of the trailer, further adapted for receiving the lag screw from below interconnecting the adapter 54″ and at least partially-threaded receptacles 57″ in the conical, or pyramidal, positioning devices 54″. In this way the mating conical, or pyramidal, positioning devices 54″ help align the threaded receptacles for easy installation of the lag screws 48″. Easy installation of the lag screws 48″ is further facilitated in that only one of the portions 54″, 46″ of the system need be threaded to make it easier to insert the lag screws 48″. The upper positioning device 54″ (shown as mating cone or pyramid 54″), extends attached permanently from a frame member 16 (see e.g., FIG. 2) of the floor frame portion 18 of the dwelling 10″.

The wheels 70 extend from an axle 72 depending partially from a wheel support structure 74 also depending from frame member 16. Another end of the axle 72 is rotatably fixed into the positioning system conical, or pyramidal, portion 54″, as shown in FIG. 5B, such that the wheel 70 extends sufficiently lower than the portion 54″ during rolling, it being the case that bracket 46″ of this embodiment, having a mating conical, or pyramidal, shaped portion 54″ is longer to extend further upwardly through the picket receptacle 17 (compared to bracket 46 shown in FIGS. 2A and 2B) to be able to account for the fact that the wheel 70 causes the positioning conical, or pyramidal, shaped portion 54″ attached to the frame member 16 to be further up away from the picket receptacle 17.

The trailer 12″ may be adapted with a winch 66, forward roller 68, and hook 71 to allow for pulling of the mobile dwelling 10″ up ramps 75 and onto the trailer, whereas rollers 69 are provided to allow for reverse pulling (using strap 69′ and hook 71′ shown in dashed configuration) of the mobile dwelling 10″ down off the trailer and down the ramps 75. A hydraulic shock may be employed in the tongue wheel 81 of the trailer 12″ to prevent harsh bouncing when the dwelling 10″ is pulled forward, and one or more stands 82 may be employed to ensure that the trailer remains stable while loading and unloading of the dwelling 10″.

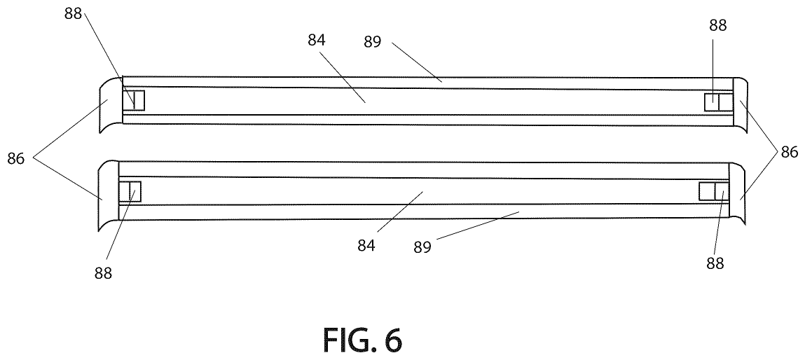

As shown in FIG. 6, the trailer 12″ may be installed using a pair of steel alloy walled (89) channels 84, each having hooks 86 adapted for hooking into slots in the frame of the trailer 12″, each of the channels 84 also comprising indents, or wheel pockets, 88 for helping retain the wheels 70 of the mobile dwelling 10″. The rear indents 88, or wheel pockets, are sufficiently slight that the first set of wheels 70 can be pulled over them with the winch 66 and winch line 67 on installation, and with the winch 66 and winch line 69 on removal. Thus, it will be appreciated that a significant portion of the retention/fixing power of the system 32″, 44″ is accomplished by the pyramidal or conical design of the interfacing adapter and stud 54″.

The dwelling 10″ may preferably be just the width of the floor of the utility trailer 12″ to avoid interference with the wheel or wheel fender upon rolling installation, de-installation. However, there may also be provided tunnel-like channels running along the outer side edges of the dwelling 10″, running parallel to the longitudinal axis of the dwelling 10″, adapted for accommodating clearance of the wheels 9 and fenders 8. Openings, either to the exterior of the sides of the dwelling 12″, or opening into the interior of the dwelling 12″, may be configured with removable drawers-to be removed during installation to accommodate clearance of the wheels and fenders, but providing for storage forward of the wheels 9 and fenders 8 if desired.

FIG. 7 shows a partial section view of an alternative embodiment of a positioning and securing system 32′, 44′ for use with secure attachment of the mobile dwelling 10, 10′ of the disclosure to picket stake receptacles 17 for a standard utility trailer 13 for example as shown in one of FIG. 1, 3, or 4. The positioning and securing system 44′ comprises a steel plate 51 having a rectangular stud member 54, 54′ extending therefrom adapted for extending down into the picket stake pocket 17 of a standard utility trailer 13. And thus, it will be appreciated that either stud member 54, stud member 54′, (or for that matter even stud member 54″), may be adapted to extend from steel plate 51 adapted for attachment to the floor frame 16, 18 of the mobile dwelling. The stud member 54, 54′ has a receptacle portion 57 (and center hole 92) defined therein, which is preferably threaded at an extent portion thereof (such threads may be accomplished either by tapping as shown or by welding a nut to an upper side of a steel inner plate). The stud member 54, 54′ extends downwardly from the steel plate portion 54, 54′ into the picket receptacle 17 as shown of the trailer frame 12 to help hold the mobile dwelling 10, 10′ in position relative to the trailer 12, and a cap member 45′ is provided with a center hole 92 for receiving the securing bolt 48, there being further provided positioning flanges 46′ adapted for cupping the bottom of the picket receptacle 17 as shown, and such that when the cap member is installed and held in place by the bolt head 48 of the bolt 48, the bolt being screwed into the threaded portion of the receptacle 54, 54′, and plate 51, there being further provided an angled tip portion 91 of the bolt 48 adapted for easily centering the bolt into the receptacle 57, both at the entrance portion of the receptacle at the lowermost extent of the stud 54, 54′ as well as at the entrance to the threaded portion 57 of the receptacle which extends in this embodiment into plate 51. It will be appreciated that the receptacle 57 may be any suitable length, whether extending into the stud 54, 54′ and plate 51, or just into the stud. The threads 48 of bolt 48 serve to secure the mobile dwelling 10, 10′ to the bed surface of the trailer 13, and the stud 54, 54′ serves to position and center the mobile dwelling on the trailer bed at, and relative to, the fence picket stake pockets of the trailer. It will be appreciated that a rubber pad may be beneficially applied to the under surface of the mobile dwelling 10, 10′ to help cushion the ride of the mobile dwelling on the trailer 13 bed.

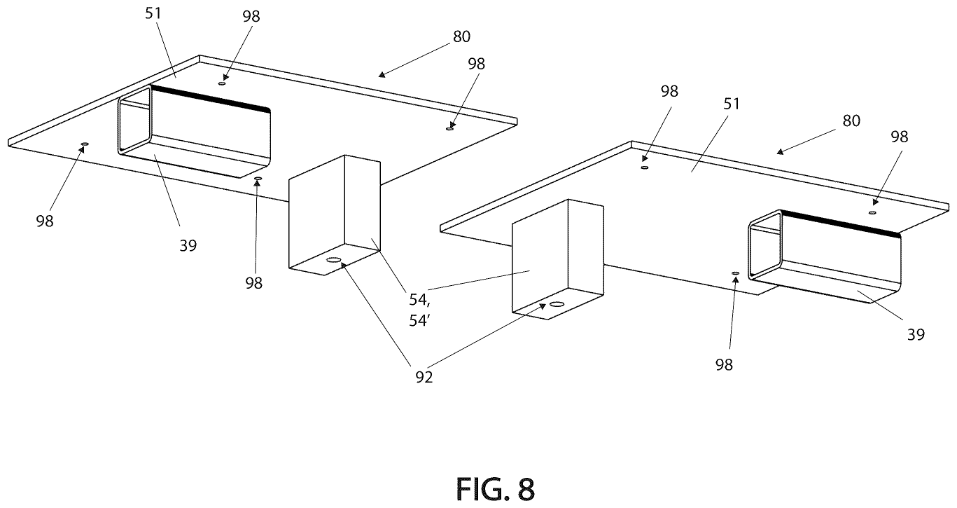

FIG. 8 shows an embodiment of a pair of preferably steel front sled plates 80 (a non-releasably attached portion of a positioning and securing system 32′, 44′ of FIG. 7 and adapted for non-releasable attachment to an aluminum floor frame portion of a mobile dwelling 10, 10′), each adapted for installation on a front corner portion of a floor frame portion 18 of a mobile dwelling 10, 10′ (though such could also be implemented in dwelling 10″), each sled plate comprising a rectangular stud portion 54, 54′ (or stud portion 54″ could also extend from such a sled plate), a plate portion 51, and side-jack receptacle portions 39. Steel plate portion 51 has holes 98 defined therein for attaching the steel plate portion with screws to an aluminum frame portion 18 of the mobile dwelling floor portion. Each stud portion 54, 54′ has a central hole (whether threaded or not, but preferably treaded at some portion thereof) 92, adapted for receiving a bolt 48 (as shown in FIG. 7) for securing the detachable mobile dwelling to a utility trailer 12 via the sled plate 80. As shown in FIG. 3, the sleeve portion 39 is adapted for receiving and retaining the horizontal member portion 35 of the side jack 38 to allow secure lifting of the dwelling unit off of, and onto, the trailer 13 bed.

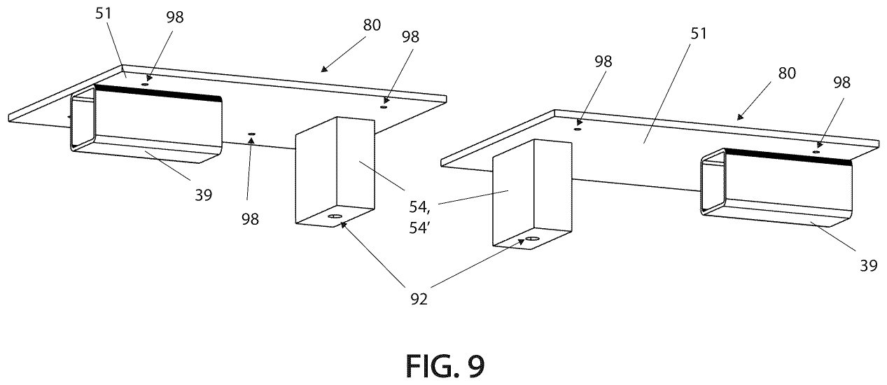

FIG. 9 shows another pair of preferably steel rear sled plates 80 (a non-releasably attached portion of a positioning and securing system 32′, 44′ of FIG. 7 and adapted for non-releasable attachment to an aluminum floor frame portion of a mobile dwelling 10, 10′), each adapted for installation on a rear corner portion of the floor frame portion 18 of the mobile dwelling 10, 10′ (though such could also be implemented in dwelling 10″), each sled plate likewise comprising a stud portion 54, 54′ (thus whether the stud portion is rectangular or otherwise shaped as described herein to help with positioning—or such sled plate could also be implemented with stud portion 54″ for dwelling 10″), a plate portion 51, and side-jack receptacle portions 39. Each stud portion 54, 54′ has a central hole (whether threaded or not, but preferably treaded at some portion thereof) 92, adapted for receiving a bolt 48 (as shown in FIG. 7) for securing the detachable mobile dwelling to a utility trailer 12 via the sled plate 80. Steel plate portion 51 has holes 98 for allowing attaching the steel sled plate portion with screws to the aluminum frame portion 18 of the floor portion, preferably at each rear corner of the frame portion to allow centering of the dwelling 10, 10′, 10″ into stake pockets 17 with receptacle portions 54, 54′ within the stake pocket, depending on the embodiment chosen-it also being the case that some embodiments have a lower receptacle 54, 54′ for mating with the configuration of the stud (whether angled, double-angled, or conical concave/convex).

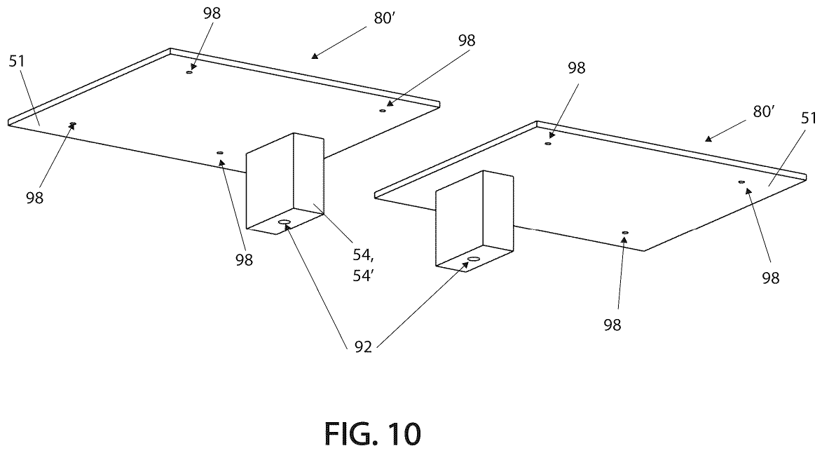

FIG. 10 shows another pair of alternative embodiment preferably steel front/rear sled plates (two such plates are shown of four total) 80′ (a non-releasably attached portion of a positioning and securing system 32′, 44′ of FIG. 7 and adapted for non-releasable attachment to a floor frame portion of a mobile dwelling 10, 10′, 10″), each adapted for installation on a front/rear portion of a corner portion of a floor frame portion 18 of a mobile dwelling 10, 10′, 10″, each sled plate comprising a stud portion 54, 54′ (or stud portion 54″ could also extend from such a sled plate), a plate portion 51 with holes 98 therein for attaching the plate portion with screws to an aluminum frame portion 18 of the floor portion. Each stud portion 54, 54′ has a central hole (whether threaded or not, but preferably treaded at some portion thereof) 92, adapted for receiving a bolt 48 for securing the detachable mobile dwelling to a utility trailer 12 via the sled plate 80.

It will be appreciated that the aforementioned front/rear sled portions enable safe lifting and lowering of the mobile dwelling 10, 10′, 10″ (in the case of the embodiments with side jack receptacles 39, and/or positioning and securement of the mobile dwelling relative to stake pockets, or other positioning member, of the utility trailer 13. For example, as shown in FIG. 3, while the sled plate 80 isn't shown, but the receptacle 39 and positioning/attachment member 54 are shown, and such a sled plate would be one way of adapting the mobile dwelling to use as per the claimed invention. Whereas in the case of sled plate 80′, such would be better suited for the embodiment of mobile dwelling shown in FIG. 1, since in that case side jack receptacles 39 are not included. And thus, the sled plates themselves, whether sled plates 80, or 80′, may be implemented in a mobile dwelling, to render it attachable/detachable from a common utility trailer, using either a cap 45′ with flanges 46′, or 45 with flanges 46, like that shown in FIG. 2C,

The frame of the detachable mobile dwellings 10, 10′, and 10″ are preferably made of aluminum for strength and lighter weight as if monolithic characteristics to allow long-lasting attachment and detachment to the utility trailer. However, the aforementioned sled plates 80, 80′ are preferably comprised of steel for sake of strength and durability in use attaching, detaching, lifting, lowering, and supporting, the detachable mobile dwelling unit. Therefore, there is provided a novel interconnection at each corner of the detachable mobile dwelling, wherein the sled plates, together with optional steel sleeves 39 for side jacking, make for a lighter, and more durable, construction detachable mobile dwelling, able to be pulled with many, even smaller engine and frame, vehicles. In other words this contributes to the lighter weight of the detachable mobile dwelling and utility trailer combination such that a larger truck may not be necessary to pull the same. In such case, each of the holes 98 of the aforementioned sled plates 80, 80′ are attachable via nut and bolt combinations to aluminum frame members of the floor frame 18, such as with aluminum 90 degree angle members, or channels, having corresponding holes therein for enabling bolt and nut interconnection of the sled plates, via their holes 98, and the aluminum floor frame.

Further, it will be appreciated that the various releasable attachment and centering devices 54, 54′ (and even 54″ with the aid of indents, or wheel pockets, 88) of the disclosure provide for locating and centering of the mobile dwelling relative to the trailer bed 13 and the fence picket stake pockets 17 thereof, not to mention location of the dwelling 10, 10′ to a relatively precise degree, since the studs 54, 54′ (and even 54″) may be implemented so as to only fit within the picket fence stake pockets within a suitable tolerance of fit (e.g., within, for example, ¼ of an inch or other suitable degree of tolerance). In other words, there may be provided, for example, a clearance of ¼ of an inch on each side (front, rear, and sides) for the fit of the studs 54, 54′ within the stake pockets, and this will ensure that the dwelling 10, 10′ will be precisely located on the trailer bed 13 according to design standards ensuring an appropriate distribution of weight on the trailer, both forward and aft, and side-to-side. Further, this shows how the design of the releasable attachment and centering devices 54, 54′ not only securely, though releasably, attaches the dwelling 10, 10′ to the trailer bed 13 but also at the same time precisely locates it as described above.

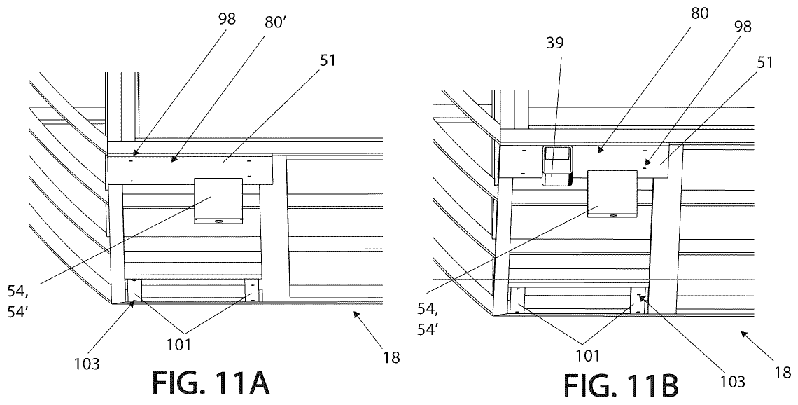

FIGS. 11A and B show bottom right side perspective views of the underside of two different right side steel sled plates 80 (with a jack sleeve 39) and 80′ (without a jack sleeve). These figures show how the plate 51 is non-releasably mounted to the floor frame 18 of the mobile dwelling 10, 10′ via welded aluminum angle brackets 101 having holes 103, the sleds plates 80, 80′ being adapted for being attached with nut and bolt combinations passing through holes 98 of the steel plates 51 and holes 103 of the angle brackets to secure the sleds 80, 80′ to the otherwise welded aluminum floor frame of the mobile dwelling in accordance with an embodiment of the disclosure. This can be seen since representative brackets 101 with holes 103 for similar front left side sled plates (the right sled plates and front left sled plates are mirror images of each other) are shown below each sled plate 80, 80′ to illustrate the framework to which each sled plate may be attached.

While a preferred embodiment of the present disclosure has been shown and described, it will be apparent to those skilled in the art that many changes and modifications may be made without departing from the claimed subject matter in its broader aspects. For example, it will be appreciated that one of ordinary skill in the art may mix and match the various components of the various embodiments of the claimed subject matter without departing from the true spirit of the claims. The appended claims are therefore intended to cover all such changes and modifications as fall within the true spirit and scope of the invention.

What is claimed is:

1. A detachable mobile dwelling adapted for use with a utility trailer having a plurality of picket stake pockets otherwise for retaining a detachable wall member of the utility trailer, the utility trailer being of a type to be towed behind a vehicle, comprising:
a dwelling body comprising:
a structural floor member forming a floor portion;
a structural side wall member forming at least one side portion interconnected with said floor portion; and
a structural front, top, and frame member forming an upper portion, each the front member, the top member, and the rear member interconnecting with at least one of said floor portion and said at least one side portion;
an entry and exit access portal in at least one of the side portion and the upper portion; and
at least one releasable attachment and centering device combination, comprising a stud portion non-releasably attached to the floor portion for engaging with one of the plurality of picket stake pockets, and further comprising an integrator comprising one of a threaded bolt member, a non-threaded pin member, and a combination threaded bolt member and non-threaded pin member, for fixing the stud portion relative to the picket stake pocket for releasably interconnecting the detachable dwelling and the utility trailer while also aiding in centering the floor frame portion on the utility trailer.

2. The detachable mobile dwelling of claim 1, wherein said at least one attachment and centering device combination further comprises an adapter portion adapted for engaging with the picket stake pocket, and wherein the integrator is adapted for fixing the stud portion and the adapter portion relative to the picket stake pocket for releasably interconnecting the detachable dwelling and the utility trailer while aiding in centering the floor frame portion on the utility trailer.

3. The detachable mobile dwelling of claim 1, wherein the floor, side, and upper portions are suitably bonded or attached to form a structural frame, and wherein at least one pick point is secured to an upper portion of the frame, to allow the detachable mobile dwelling to be structurally adapted to be lifted via a central line from above via the at least one pick point.

4. The detachable mobile dwelling of claim 2, wherein the side portion comprises a plurality of side portions, and wherein the floor portion, the plurality of side portions, and the upper portion are suitably bonded or attached to enable the mobile dwelling to be jacked from side jacks adapted to be lifted adjacent the side portions to thereby enable deposit of the mobile dwelling on, and for removal of the mobile dwelling from, the utility trailer.

5. The detachable mobile dwelling of claim 2, further comprising wheel members mounted on an underside of the floor portion, and wherein the floor portion, the side portion, and the upper portion are suitably bonded or attached to enable the mobile dwelling unit to be rolled up ramps to enable deposit of the mobile dwelling on, and removal of the mobile dwelling from, the utility trailer.

6. The detachable mobile dwelling of claim 2, wherein the adapter portion further comprises a seat for interfacing with the stud portion, and wherein the integrator comprises a threaded bolt adapted to be inserted through the stud portion and the adapter portion, the integrator further being inserted at least partially within one of the picket fence pockets for positionally fixing the detachable mobile dwelling on the utility trailer.

7. The detachable mobile dwelling of claim 6, wherein the threaded bolt adapted for being inserted into the adapter portion and the stud portion further comprises a faceted leading portion adapted for facilitating securement of the lag screw within the stud portion for interconnecting and centering the floor frame portion relative to the utility trailer.

8. The detachable mobile dwelling of claim 7, wherein each of the stud portion and the adapter portion of said releasable attachment and centering device combination further comprises as a seated portion a positioning member comprising one of mating cones and mating pyramid-shaped faces adapted for centrally aligning for communicating of receptacles for the lag screw and aiding in securing positioning of the mobile dwelling relative to the utility trailer.

9. The detachable mobile dwelling of claim 3, further comprising laminated floor and siding members attached to the structural frame.

10. The detachable mobile dwelling of claim 1, further comprising a jack system, wherein the mobile dwelling is able to be jacked up for installation and removal of the mobile dwelling unit from the utility trailer using the jack system, the at least one releasable attachment and centering device combination further comprising an attached jack sleeve adapted for releasably receiving a horizontal member of the jack system.

11. The detachable mobile dwelling of claim 1, combined with a utility trailer having had its sides used for utility trailer purposes removed and the detachable mobile dwelling releasably attached to the utility trailer.

12. The detachable mobile dwelling of claim 10, wherein the at least one side portion comprises a plurality of side portions, wherein the side jack system comprises a plurality of side jack members, and wherein each side jack member comprises a wheeled attachment for enabling wheeling the mobile dwelling on a surface when it is not installed on the utility trailer.

13. A detachable mobile dwelling adapted for use with a utility trailer comprising a plurality of picket stake pockets, comprising:
a dwelling body comprising a frame further comprising:
a plurality of interconnected structural floor members forming a floor frame portion;
a plurality of interconnected structural side wall members forming at least one side frame portion interconnected with said floor frame portion; and
a plurality of upper structural members, forming front, top, and rear frame members each interconnecting with at least one of said floor frame portion and said at least one side frame portion;
an entry and exit access portal in at least one of the plurality of side wall members and the plurality of upper structural members; and
a plurality of attachment and centering device combinations, each such combination comprising a stud portion, a corresponding adapter portion, and a corresponding integrator portion, the stud portion being adapted for engaging and interconnecting with the floor portion, the adapter portion adapted for engaging with a corresponding one of the plurality of picket stake pockets, and the integrator portion comprising one of a threaded bolt member, a pin member, and a combination threaded bolt member and pin member, the integrator portion being adapted for interconnecting the adapter portion and the stud portion for aiding in centering and fixing the mobile dwelling body relative to the corresponding stake pocket to aid in releasably interconnecting and centering the floor frame portion on the utility trailer.

14. The detachable mobile dwelling of claim 13, further comprising a jack system, wherein each of the plurality of releasable attachment and centering device combinations further comprises an attached jack sleeve adapted for releasably receiving a horizontal member of the jack system to enable the mobile dwelling to be lifted to thereby enable deposit of the mobile dwelling on, and for removal of the mobile dwelling from, the utility trailer.

15. The detachable mobile dwelling of claim 1, further comprising wheel members adapted to be mounted to each stud portion for wheeling the dwelling body up ramps for deposit on, and removal from, the utility trailer.

16. The detachable mobile dwelling of claim 9, further comprising laminated aluminum and plastic floor and siding members attached to the frame portions.

17. A releasable attachment and centering device system adapted for use in detachably attaching a mobile dwelling comprising a mobile dwelling body having a floor portion to a utility trailer having a plurality of picket stake pockets on a periphery around a bed of the utility trailer, comprising:
a stud portion;
a corresponding adapter portion; and
a corresponding integrator portion, said integrator portion comprising one of a threaded bolt member, a pin member, and a combination threaded bolt member and pin member, said integrator, in combination with said stud portion and said corresponding adapter portion, being adapted for fixing and centering the floor portion of the mobile dwelling to the bed of the utility trailer via a plurality of the plurality of picket stake pockets.

18. The releasable attachment and centering device combination of claim 17, wherein said stud portion further comprises a plate adapted to be non-releasably attached to the floor portion, the stud portion also being adapted for engaging with one of the plurality of picket stake pockets, and wherein said adapter portion is comprised of one of a flanged seat for interfacing with said stud portion and a flanged cap, said adapter portion being adapted for engaging the one of the plurality of picket stake pockets, and wherein the integrator comprises a partially-threaded bolt member, the integrator being adapted for fixing the stud portion and the adapter portion to each other and relative to the picket stake pocket to be adapted for releasably interconnecting the detachable dwelling and the utility trailer while also being adapted for aiding in centering the floor frame portion on the utility trailer.

19. The releasable attachment and centering device combination of claim 18, further comprising an attached jack sleeve adapted for releasably receiving a horizontal member of a side jack system and adapted to enable the mobile dwelling to be lifted to enable depositing the mobile dwelling on, and for removal of the mobile dwelling from, the utility trailer.
